(19) United States
(12) Patent Application Publication
(10) Pub. No.: US 2026/0001227 A1
(43) Pub. Date: Jan. 1, 2026

(54) REPOSITIONABLE SENSOR SYSTEMS FOR AUTONOMOUS VEHICLES AND METHODS OF REPOSITIONING A SENSOR PACKAGE

(71) Applicant: Torc Robotics, Inc., Blacksburg, VA (US)

(72) Inventors: Maximilian Koeper, Ostfidern (DE); Marat Kopytjuk, Heilbronn (DE); Simon Baeuerle, Kassel (DE); Margarita Kunjavskaja, Gerlingen (DE); Maximilian Yassine Beyen, Leutenbach (DE)

(21) Appl. No.: 18/759,414

(22) Filed: Jun. 28, 2024

(51) Int. Cl. B25J 9/16; B60W 50/00; B64U 70/93

(52) U.S. Cl. CPC B25J 9/1669; B64U 70/93; B60W 2050/0083; B60W 2300/14

(57) ABSTRACT

A method of repositioning a sensor package mounted to an autonomous vehicle cabin and communicatively coupled to a computing system of the autonomous vehicle by a cable includes determining that a trailer has been attached to the cabin and removing the sensor package from the cabin with a repositioning device after determining that the trailer has been attached to the cabin. The method also involves moving the sensor package to a rear of the trailer with the repositioning device, positioning the sensor package on the rear of the trailer, and securing the sensor package on the trailer using a retainer. A repositionable sensor system for an autonomous vehicle is also provided that includes a sensor package and a repositioning device. The repositioning device removes the sensor package, moves the sensor package to a rear of the trailer, and positions the sensor package on the trailer.

### TECHNICAL FIELD

The present disclosure relates generally to the field of sensor systems for autonomous vehicles. More specifically, the present disclosure relates to repositionable sensor systems for autonomous vehicles, and methods of repositioning a sensor package on an autonomous vehicle.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Perception technologies generally use sensors like a camera, a radio detection and ranging (RADAR) sensor, a light detection and ranging (LiDAR) sensor for detecting the surrounding environment of the autonomous vehicle. However, such sensors are generally located on the autonomous vehicle cabin as opposed to the trailer, which is attached to the cabin. Accordingly, the trailer, when attached, can block some of the sensors of the autonomous vehicle cabin which results in a blind spot being formed behind the trailer. The sensors are unable to capture a suitable amount of data in the blind spot regarding the surrounding environment, which can limit the calculations that the perception technologies can perform and the vision of the perception technologies due to lack of detected information. This can result in obstacles or vehicles in the blind spot going undetected. For example, the autonomous vehicle may not recognize that an emergency vehicle with an active siren is behind them in the blind spot.

Additionally, sensors cannot be easily pre-installed on trailers at least because trailers are manufactured by many different companies including some companies that are not autonomous vehicle focused and only manufacture “standard” trailers, autonomous vehicle cabins often swap or change trailers whenever they enter a hub (e.g., they may swap with a “standard” trailer), sensors can require specific cables/connections for specific cabins in order to properly integrate with the cabin's advanced driver assistance system (ADAS), and different autonomous truck companies having different sensor arrangements/requirements may have to transport the same trailer at different times. Accordingly, pre-installing sensors on trailers may require a level of uniformity between sensor installations, trailers, and autonomous vehicle systems that is not currently present.

Moreover, adding sensors to every trailer upon connection would require time consuming manual work each time a trailer is connected to an autonomous vehicle cab.

Accordingly, there exists a need to easily add sensors to trailers connected to autonomous vehicles with minimal to no operator involvement required.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

The present disclosure relates to repositionable sensor systems for vehicles, and methods of repositioning a sensor package on a vehicle.

In accordance with aspects of the present disclosure, a method of repositioning a sensor package mounted to a cabin of an autonomous vehicle and communicatively coupled to a computing system of the autonomous vehicle by a cable is provided. The method involves determining that a trailer has been attached to the cabin of the autonomous vehicle and removing the sensor package from the cabin with a repositioning device after determining that the trailer has been attached to the cabin. The method also involves moving the sensor package to a rear of the trailer with the repositioning device, positioning the sensor package on the rear of the trailer, and securing the sensor package on the trailer using a retainer.

In some aspects, the repositioning device can be a drone capable of flight. In such aspects, moving the sensor package can include aerially transporting the sensor package to the rear of the trailer. In other such aspects, the drone and the sensor package can be a single integral unit.

In some other aspects, the repositioning device can include a robotic arm mounted external to the cabin. In such aspects, removing the sensor package from the cabin can include grabbing the sensor package with the robotic arm.

In still other aspects, removing the sensor package from the cabin and moving the sensor package to the rear of the trailer can be performed automatically upon determining that the trailer has been attached to the cabin.

In some aspects, the method can also involve receiving a signal from a user to activate the repositioning device, and the steps of removing the sensor package from the cabin and moving the sensor package can be performed upon receiving the signal.

In other aspects, the method can also involve securing the cable to the trailer and/or tightening the cable upon securing the sensor package on the trailer.

In some other aspects, the method can involve identifying a landing zone on the trailer containing the retainer and positioning the sensor package on the landing zone. In such aspects, the landing zone can be identified using a computer vision system of the repositioning device.

A repositionable sensor system for an autonomous vehicle is also provided according to the present disclosure. The repositionable sensor system includes a sensor package and a repositioning device. The sensor package includes a plurality of sensors and is mountable on a cabin of the autonomous vehicle. The sensor package is additionally configured to be communicatively coupled to a computing system of the autonomous vehicle. The repositioning device removes the sensor package after determining that a trailer has been attached to the cabin, moves the sensor package to a rear of the trailer, and positions the sensor package on the rear of the trailer.

In some aspects, the repositioning device can include a drone capable of flight. In such aspects, the repositioning device can move the sensor package by aerially transporting the sensor package to the rear of the trailer. In such aspects, the drone and the sensor package can be a single integral unit.

In other aspects, the repositioning device can include a robotic arm mounted external to the cabin. In such aspects, the repositioning device can remove the sensor package by grabbing the sensor package with the robotic arm.

In still other aspects, the repositioning device can remove the sensor package and move the sensor package to the rear of the trailer automatically after determining that the trailer has been attached to the cabin, or upon receiving a signal from a user to activate the repositioning device.

In some other aspects, the system can include a cable that is connected to the sensor package and configured to be communicatively coupled to the computing system of the autonomous vehicle. In such aspects, the system can include means for securing the cable to the trailer, a retainer configured to secure the sensor package on the trailer, and/or means for tightening the cable upon securing the sensor package on the trailer with a retainer. In other such aspects, the cable can be positioned within a cable holder that laterally secures the cable.

In still other aspects, the system can include a retainer that is configured to secure the sensor package on the trailer. In such aspects, the repositioning device can identify a landing zone on the trailer containing the retainer and position the sensor package on the landing zone. In such aspects, the repositioning device can include a computer vision system and can identify the landing zone using the computer vision system.

Other features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

The foregoing features of the present disclosure will be apparent from the following Detailed Description of the Invention, taken in connection with the accompanying drawings, in which:

FIG. 1 is a schematic view of an autonomous vehicle of the present disclosure;

FIG. 2 is a block diagram of the autonomous vehicle shown in FIG. 1;

FIG. 3 is a block diagram of an example computing system of the present disclosure;

FIG. 4 is top aerial view of an autonomous vehicle and connected trailer on a roadway illustrating a sensor blind spot;

FIG. 5 is a side plan view of an autonomous vehicle including an exemplary repositioning device and a sensor package of the present disclosure;

FIG. 6A is a side plan view of the autonomous vehicle of FIG. 5 and a trailer attached thereto;

FIG. 6B is a side plan view of the autonomous vehicle and trailer of FIG. 6A illustrating the repositioning device in the process of transferring the sensor package to the trailer;

FIG. 6C is a side plan view of the autonomous vehicle and trailer of FIG. 6A illustrating the repositioning device positioning the sensor package on the trailer;

FIG. 6D is a partial top view of the autonomous vehicle and trailer of FIG. 6C showing the repositioning device and sensor package positioned on a landing zone of the trailer;

FIG. 7A is a side plan view of the autonomous vehicle, trailer, repositioning device, and sensor package of FIG. 6A with an exemplary cable securing device of the present disclosure;

FIG. 7B is a side plan view of the autonomous vehicle and trailer of FIG. 7A illustrating the repositioning device in the process of transferring the sensor package to the trailer;

FIG. 7C is a side plan view of the autonomous vehicle and trailer of FIG. 7A illustrating the repositioning device positioning the sensor package on the trailer;

FIG. 8A is a side plan view of the autonomous vehicle and trailer including the sensor package illustrating an alternative repositioning device in the process of removing the sensor package;

FIG. 8B is a side plan view showing the repositioning device of FIG. 8A positioning the sensor package on the trailer; and

FIG. 9 is an exemplary flow chart illustrating steps for repositioning a sensor package on a trailer of an autonomous vehicle.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

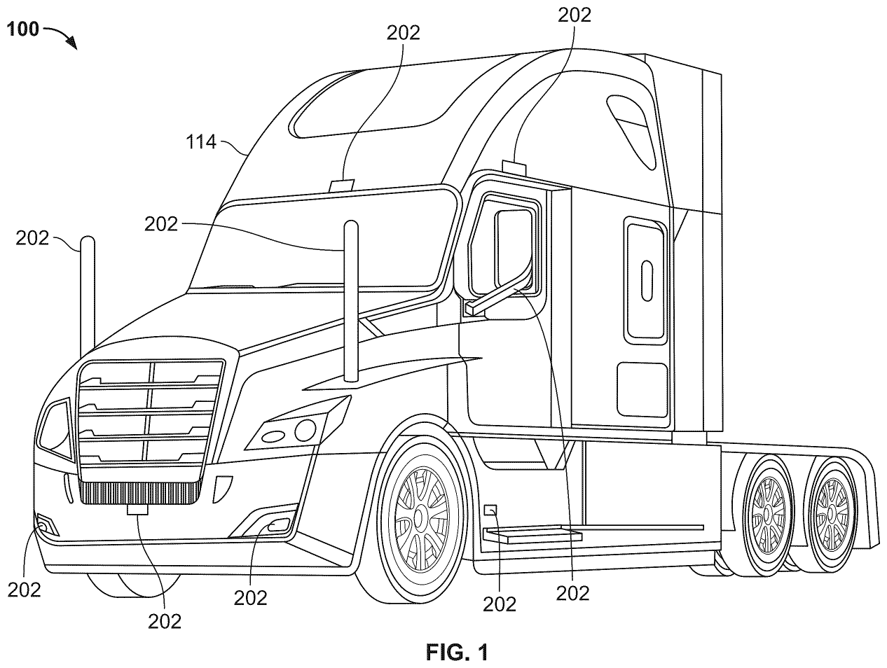

The present disclosure relates to repositionable sensor systems for autonomous vehicles and methods of repositioning a sensor package on an autonomous vehicle, as described in detail below in connection with FIGS. 1-9.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

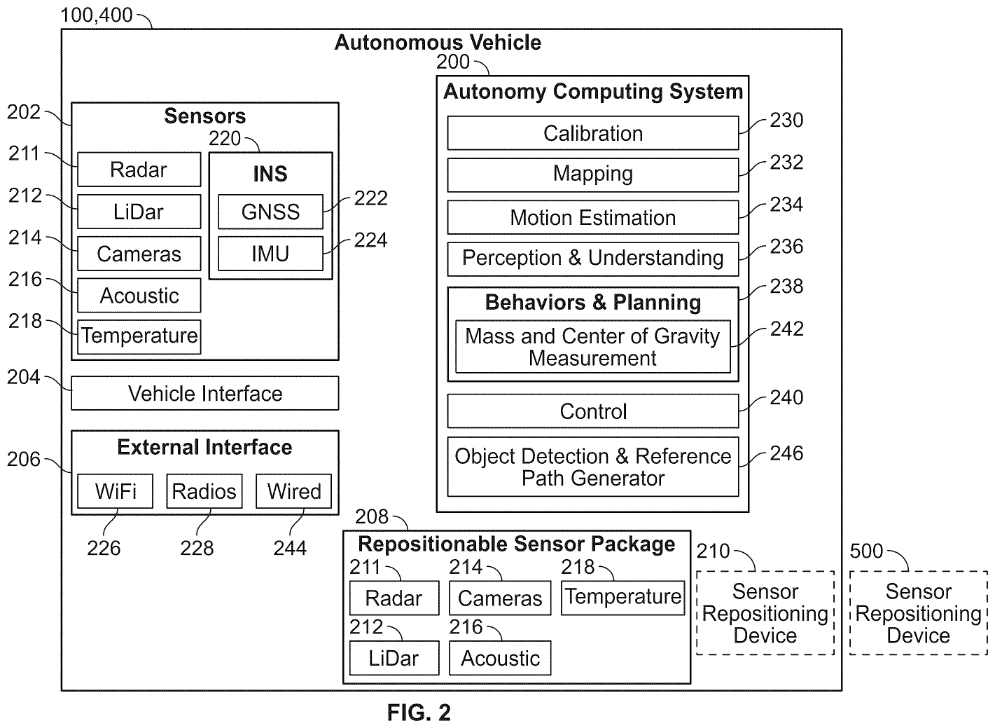

The vehicle 100 may be an autonomous vehicle, in which case the vehicle 100 may omit the steering wheel and the steering column to steer the vehicle 100. Rather, the vehicle 100 may be operated by an autonomy computing system 200 (see FIG. 2) of the vehicle 100 based on data collected by a sensor network including one or more sensors, e.g., sensors 202 and repositionable sensor package 208 shown in FIG. 2.

FIG. 2 is a block diagram of autonomous vehicle 100 shown in FIG. 1. In the example embodiment, the autonomous vehicle 100 includes an autonomy computing system 200, sensors 202, a vehicle interface 204, external interfaces 206, a repositionable sensor package 208, and repositioning device 210, which can be a repositioning device.

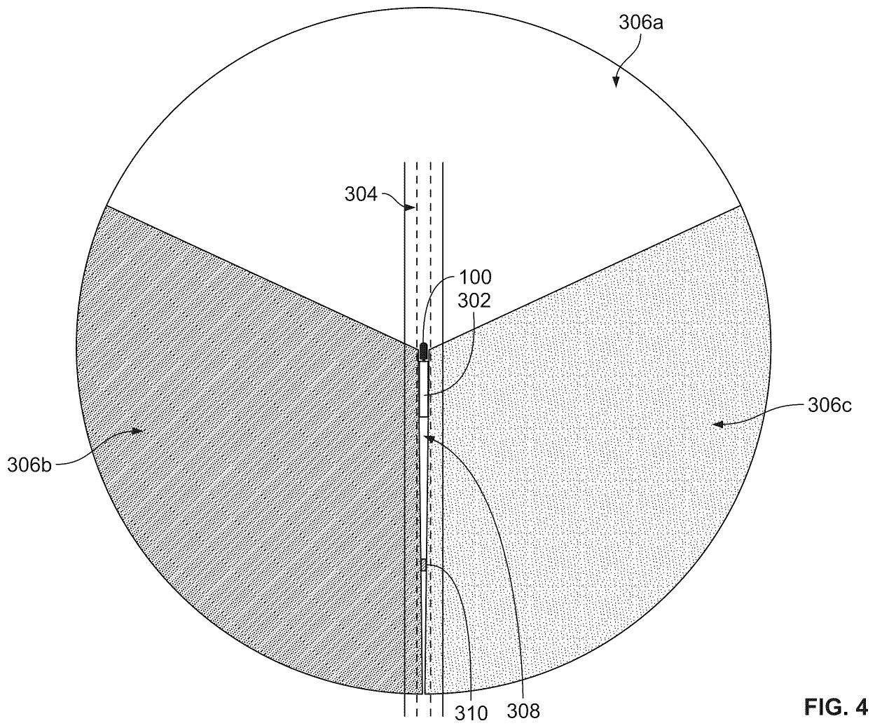

In the example embodiment, the sensors 202 may include various sensors such as, for example, radio detection and ranging (RADAR) sensors 211, light detection and ranging (LiDAR) sensors 212, cameras 214, acoustic sensors 216, temperature sensors 218, and/or an inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound, microphones, etc.), internal vehicle sensors, meteorological sensors, a hygrometer, a rain gauge, or other types of sensors. The sensors 202 can be positioned in various locations on the vehicle 100, as shown in FIG. 1. For example, the sensors 202 can be positioned on the side of the vehicle 100, on the front bumper of the vehicle 100, on mirrors of the vehicle 100, in the cab of the vehicle 100, on the top of the vehicle 100, etc. However, the sensors 202 are generally limited to the vehicle 100, and trailers attached to the vehicle 100 generally do not include sensors 202, which can lead to blind spots, as discussed in connection with FIG. 4. The sensors 202 generate respective output signals based on detected physical conditions of the autonomous vehicle 100 and its proximity. As described in further detail below, these signals may be used by autonomy computing system 200 to determine how to control operations of the autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below the autonomous vehicle 100 may be captured. In some embodiments, the FOV may be limited to particular areas around the autonomous vehicle 100 (e.g., forward of autonomous vehicle 100, to the sides of the autonomous vehicle 100, etc.) or may surround 360 degrees of the autonomous vehicle 100. In some embodiments, the autonomous vehicle 100 includes multiple cameras 214, and the images from each of the multiple cameras 214 may be processed to identify one or more construction markers or other objects in the environment surrounding the autonomous vehicle 100. In some embodiments, the image data generated by the cameras 214 may be sent to the autonomy computing system 200 or other aspects of the autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below the autonomous vehicle 100 can be captured and represented in the LiDAR point clouds. RADAR sensors 211 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from the cameras 214, RADAR sensors 211, or LiDAR sensors 212 may be used in combination to identify one or more construction markers (or nodes) around the autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors) and/or repositionable sensor package 208. External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway. In some aspects, the repositionable sensor package 208 can be connected to the external interfaces 206.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202 or the repositionable sensor package 208. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

The mass and center of gravity measurement module 242 may perform one or more tasks including, but not limited to, receiving data corresponding to the total mass and the center of gravity of autonomous vehicle 100 with a trailer loaded with goods. Data corresponding to the total mass and the center of gravity may be based on measurements performed at a hub, while autonomous vehicle 100, is in a parked position, using multiple image sensors (or cameras) mounted or positioned at the hub. Additionally, or alternatively, data corresponding to the total mass and the center of gravity may be based on measurements performed at the hub using multiple weight sensors (e.g., strain gage-based sensors) positioned at the hub to measure force or weight applied at multiple measurement points (e.g., at each wheel of autonomous vehicle 100 and a connected trailer).

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

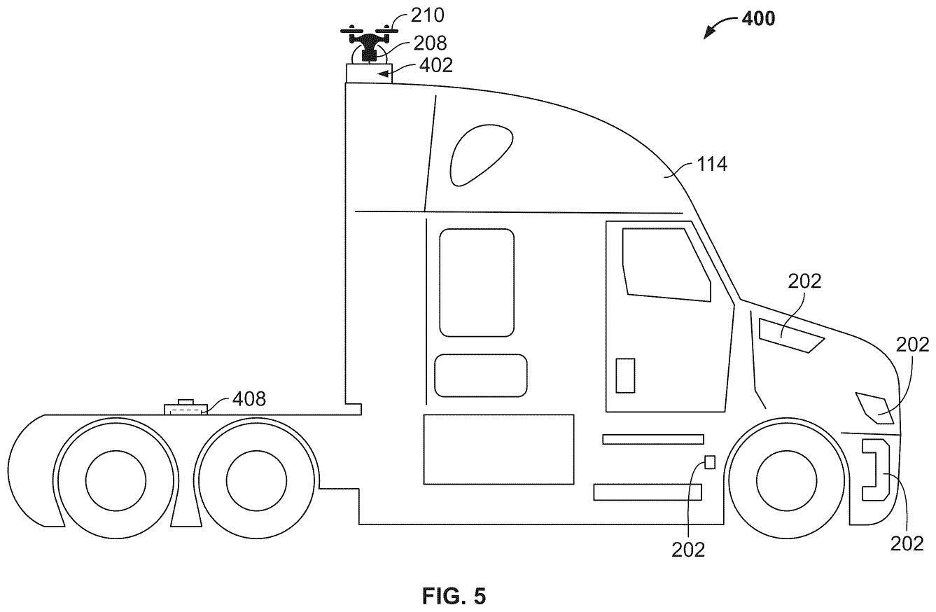

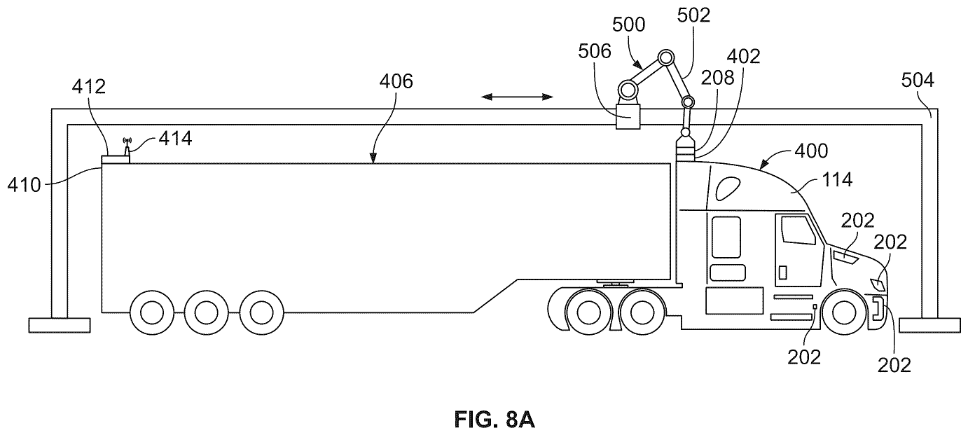

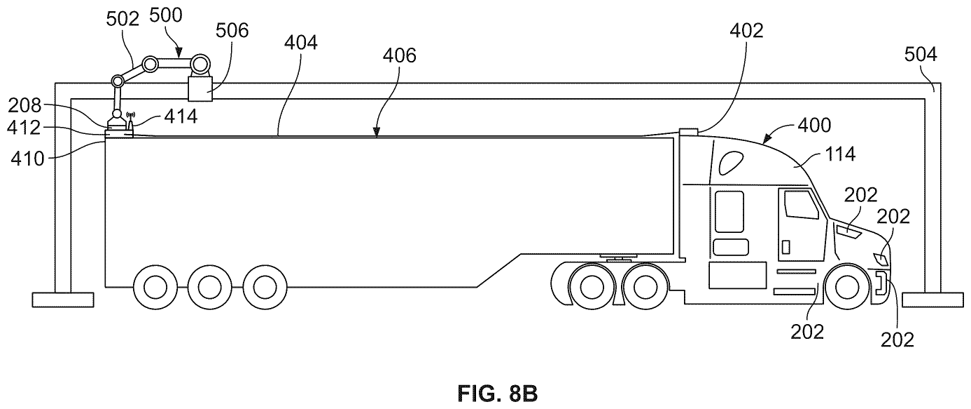

The repositionable sensor package 208 is positioned on an exterior of the autonomous vehicle 100, e.g., on the cabin 114, and communicatively coupled to the autonomy computing system 200, e.g., by way of a cable. The sensor package 208 may include various sensors, including, for example, additional radar sensors 211, LiDar sensors 212, cameras 214, acoustic sensors 216, and/or temperature sensors 218, as well as other sensors known in the art. The repositionable sensor package 208 is configured to be removed from the autonomous vehicle 100 by the repositioning device 210 and repositioned on a trailer connected to the autonomous vehicle, which is discussed in greater detail in connection with FIGS. 5-9. The repositioning device 210 can be provided as a part of the autonomous vehicle 100 (as shown, for example, in FIGS. 5-7C), or as a separate device that is not a part of the autonomous vehicle 100 and does not travel with the autonomous vehicle 100 (as shown, for example, in FIGS. 8A and 8B).

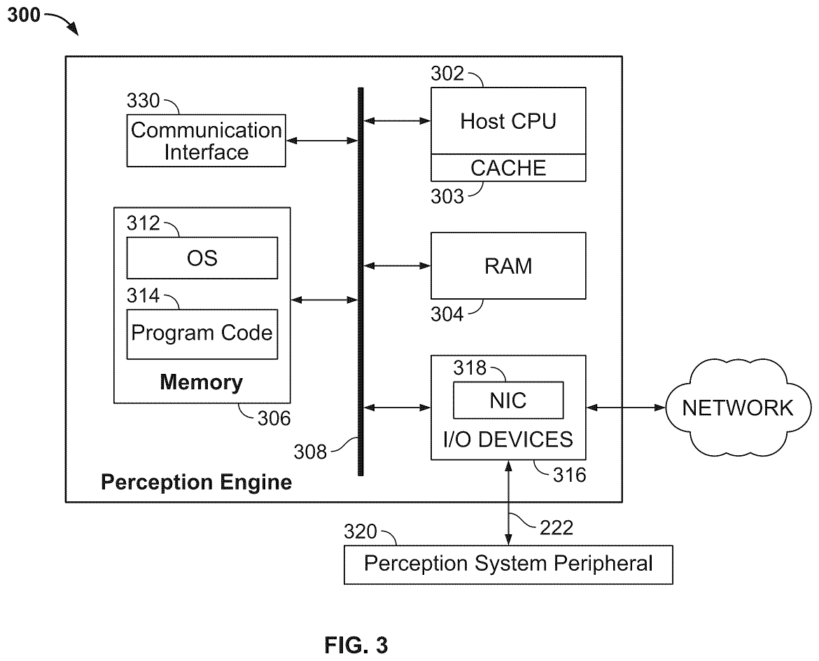

FIG. 3 is a block diagram of an example computing system 300, such as the autonomy computing system 200 shown in FIG. 2, configured for sensing an environment in which the autonomous vehicle 100 is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus. The repositionable sensor package 208 can be provided as an I/O device 316 that is in connection with the bus 308, e.g., by a cable. Additionally, the repositioning device 210 can be in communication with the host CPU 302 via the bus 308 such that the host CPU can control the repositioning device 210.

FIG. 4 is a top aerial view of the autonomous vehicle 100 with a trailer 302 connected thereto on a roadway 304. As shown in FIG. 1, the sensors 202 are positioned on the vehicle 100 in a configuration such that they are capable of capturing data (e.g., data, information, characteristics, etc.) pertaining to the autonomous vehicle 100 and of the entire environment surrounding the autonomous vehicle 100. For example, sensors 202 positioned on the front of the vehicle 100 can be capable of capturing data in a front one-third sector 306a surrounding a portion of the vehicle 100, sensors 202 positioned on the left side of the vehicle 100 can be capable of capturing data in a left side one-third sector 306b surrounding a portion of the vehicle 100, and sensors 202 positioned on the right side of the vehicle 100 can be capable of capturing data in a right side one-third sector 306c surrounding a portion of the vehicle 100. However, when a trailer 302 is connected to the autonomous vehicle 100, the trailer 302 can block the sensors 202 used to capture data and detect the environment behind the autonomous vehicle 100, which results in a blind spot 308 being formed behind the trailer 302. The sensors 202 are unable to capture any data in the blind spot 308, which can limit the calculations that the autonomy computing system 200 can perform and vision of the autonomy computing system 200 due to lack of detected information. This can result in obstacles or vehicles 310 in the blind spot 308 going undetected. For example, the autonomous vehicle 100 may not recognize that an emergency vehicle with an active siren is behind them in the blind spot 308.

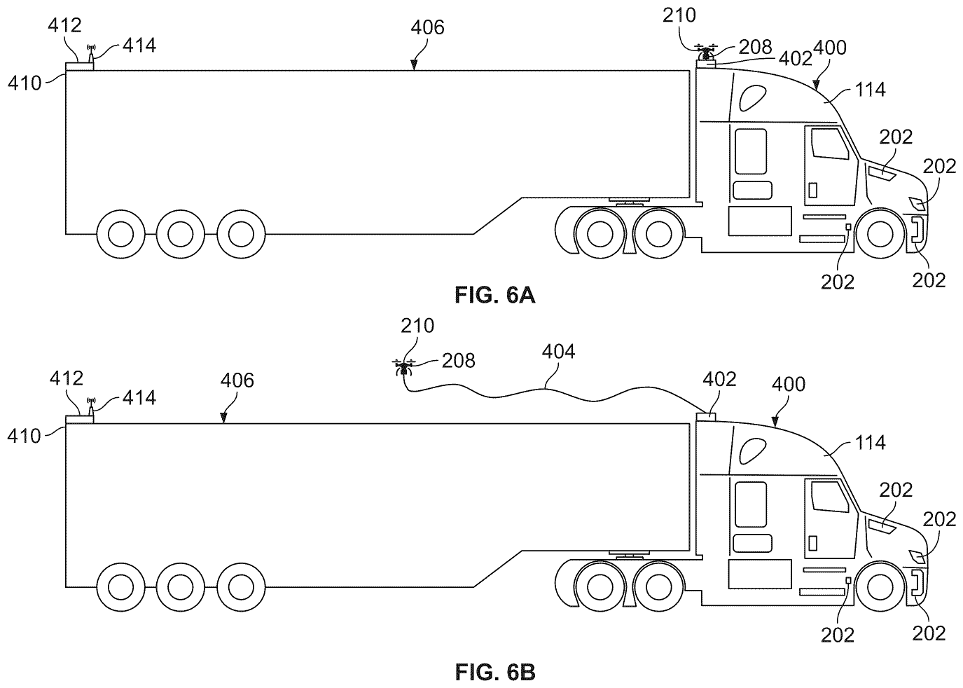

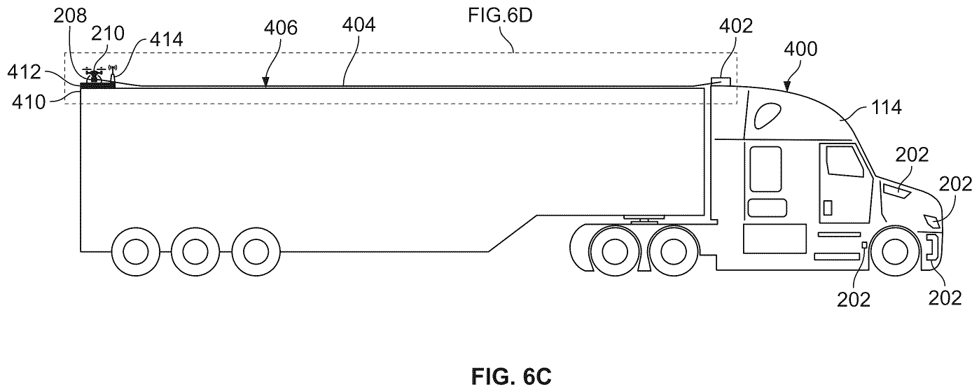

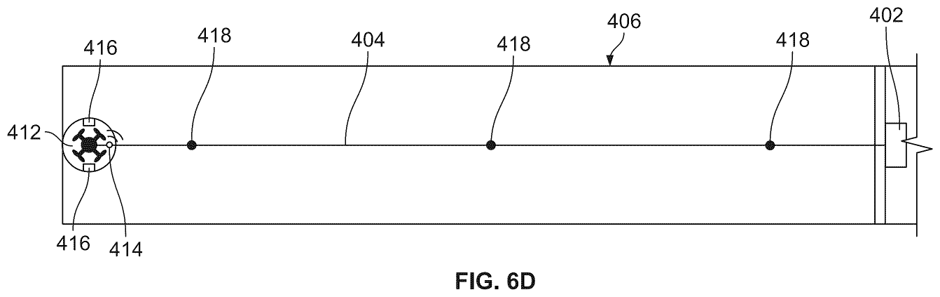

FIG. 5 is a side plan view of an autonomous vehicle 400 including the sensor package 208 and the repositioning device 210 secured thereto. Autonomous vehicle 400 can be substantially similar to autonomous vehicle 100 shown and described in connection with FIG. 1, but for any differences noted herein. Accordingly, details thereof need not be repeated. The autonomous vehicle 400 can include a cable spool 402, which can be positioned on a top of the cab 114, recessed into the cab 114, or positioned inside the cab 114. The cable spool 402 houses a power and data cable 404 that is connected between the sensor package 208 and the computing system 200, 300, which can be an advanced driver assistance system, of the autonomous vehicle 400. Accordingly, the sensor package 208 and repositioning device 210 can receive power and control instructions through the power and data cable 404, and can transfer sensor data to the computing system 200, 300 through the power and data cable 404. The power and data cable 404 can be wound onto the spool 402 and subsequently unwound when the repositioning device 210 launches, and as the repositioning device 210 travels to the rear of a trailer, as discussed in connection with FIGS. 6A-C. The power and data cable 404 can also be detachable from the repositioning device 210 and sensor package 208, and/or the autonomous vehicle 400 to allow for replacement of various components including, for example, the repositioning device 210, the sensor package 208, the power and data cable 404, and the cable spool 402. The cable spool 402 can also function as a mount for the repositioning device 210, which can be initially positioned on top of and secured to the cable spool 402.

FIG. 6A is a side plan view of the autonomous vehicle 400 with a trailer 406 attached thereto. The autonomous vehicle 400 can include one or more sensors 408 (see FIG. 5), which can be included in sensors 202 or sensor package 208, that detect attachment of the trailer 406 to the autonomous truck 400. Upon determining that the trailer 406 is attached and safely secured to the autonomous truck 400, the repositioning device 210 automatically deploys from the cab 114. The foregoing determination can be made by the repositioning device 210 itself or by the computing system 200, 300 based on the one or more sensors 408. Additionally and/or alternatively, the cab 114 can be provided with a button or actuation means, e.g., in an interior thereof, that can be engaged by an operator to deploy the repositioning device 210 once the trailer 406 is attached and safely secured to the autonomous truck 400, as opposed to the repositioning device 210 deploying automatically without operator involvement.

The repositioning device 210 can be an aerial drone, e.g., a single or multirotor drone, that is capable of flying from the cab 114 to a rear portion 410 of the trailer 406, which can have a landing zone 412 secured thereto. However, it should be understood that the repositioning device 210 need not be an aerial drone, but instead can be provided as any other robotic device that is capable of automatically transferring and repositioning the sensor package 208 from the cab 114 to the landing zone 412 on the rear of the trailer 406 while requiring minimal to no operator interaction. For example, the repositioning device 210 can be provided with one or more wheels or mechanical legs as motive means.

FIG. 6B is a side plan view of the autonomous vehicle 400 and trailer 406 of FIG. 6A illustrating the repositioning device 210 in the process of transferring the sensor package 208 to the landing zone 412 on the rear 410 of the trailer 406. As the repositioning device 210 flies from the cab 114 toward the rear of the trailer 406 with the sensor package 208, the spool 402 allows for the power and data cable 404 to be drawn therefrom. The spool 402 can also be motorized such that it actively dispenses additional length of the power and data cable 404 as it is needed by the repositioning device 210. The repositioning device 210 can identify the landing zone 412 on the top rear of the trailer 406 using data obtained by the sensor package 208 and/or a computer vision system of the repositioning device 210 or the computing system 200. Alternatively, the landing zone 412 can include a beacon 414 that transmits a signal to the repositioning device 210 and the repositioning device 210 can identify the landing zone 412 based on the transmitted signal.

The repositioning device 210, including the sensor package 208, lands on the landing zone 412 where it is secured in place, as shown in FIGS. 6C and 6D, which are side plan and partial top views of the autonomous vehicle 400 and trailer 406 of FIGS. 6A and 6B, respectively. The landing zone 412 can include one or more retainers 416 that secure the repositioning device 210 and sensor package 208 to the landing zone 412, thus preventing the repositioning device 210 and sensor package 208 from becoming dislodged during travel of the autonomous vehicle 400 and trailer 406. For example, the one or more retainers 416 can include any combination of hooks, fasteners, magnets, cages, or other mechanical, electromechanical, or magnetic securing means. The landing zone 412 is located at a top rear 410 of the trailer 406 and positioned such that the sensor package 208, when relocated thereto, is capable of collecting data pertaining to the area behind the trailer 406, including the blind spot 308 (see FIG. 4) created by the trailer 406, and provides the sensed data to the computing system 200, 300. In doing so, the computing system 200, 300 has sensor data for a full 360 degrees around the autonomous vehicle 400.

The landing zone 412, with or without retainers 416, can be provided by on operator on the top of the trailer 406. For example, the landing zone 412 can be a platform that can be easily placed and secured on the top of the trailer 406, e.g., it can be a magnetic platform that magnetically engages the trailer 406, by the operator without requiring calibration or other operator involvement beyond merely placement of the landing zone 412. It is additionally noted that the repositioning device 210 can include the retainers 416 as opposed to the landing zone 412, or can include corresponding elements that mate with the retainers 416.

Once the repositioning device 210 and sensor package 208 are secured to the landing zone 412, e.g., via the retainers 416, the spool 402, which, as previously noted, can be motorized, can tighten the power and data cable 404 to prevent wavering, e.g., lateral movement, thereof. That is, the spool 402 can function as a winch. It is noted that a separate cable can be provided with and attached to the power and data cable 404, and the separate cable can be tightened by the spool 402 as opposed to the power and data cable 404 itself. Additionally, the power and data cable 404 can be provided with one or more securing means 418 for securing the power and data cable 404 to a top of the trailer 406 and prevent movement of the power and data cable 404. The securing means 418 can be, for example, magnets, electromagnets, hook and loop fasteners, or other temporary fastening devices.

Additionally, once the repositioning device 210 and sensor package 208 are secured to the landing zone 412, the sensor package 208 can undergo a calibration procedure to ensure that all sensors 211, 212, 214, 216, 218 thereof are properly calibrated based on their location and providing the desired information to the computing system 200, 300.

The repositioning device 210, including the sensor package 208, can return to the spool 402 when the autonomous vehicle 400 and trailer 406 arrive at their destination prior to removal of the trailer 406.

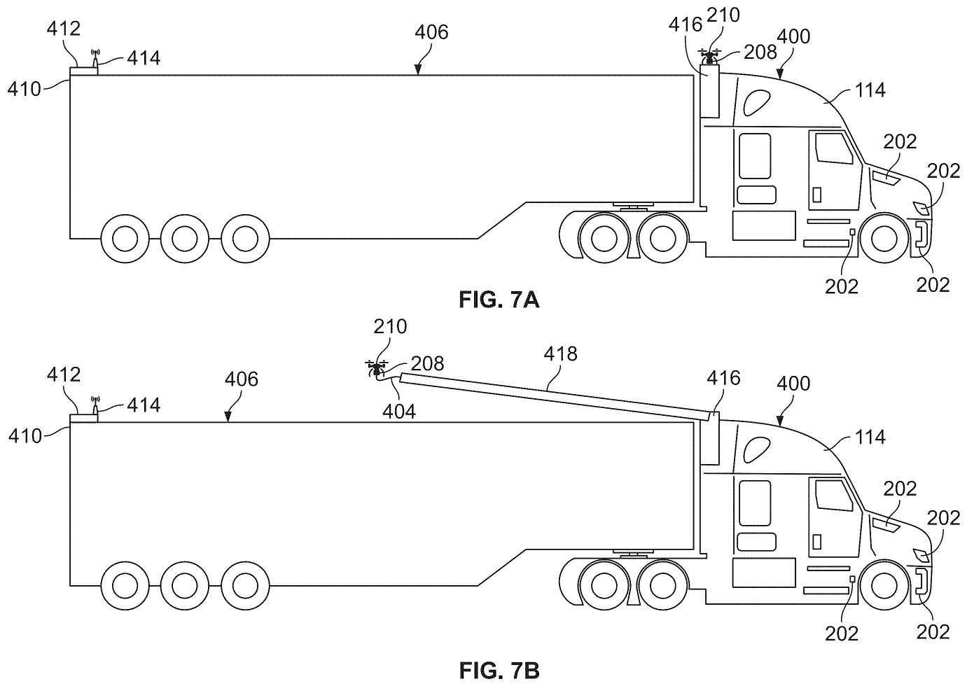

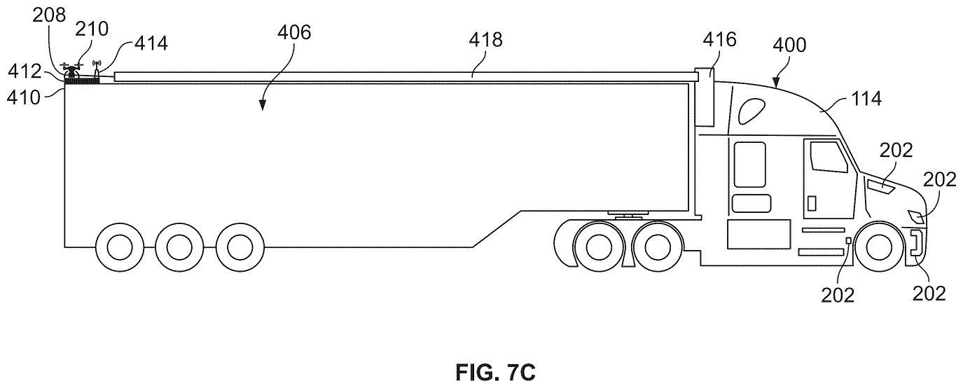

FIGS. 7A-7C illustrate the autonomous vehicle 400 and trailer 406 of FIG. 6A with an alternative spool 416 and cable securing device 418. In particular, the autonomous vehicle 400 can include a spool 416 that not only houses the power and data cable 404, but also an expandable cable securing device 418. The expandable cable securing device 418 can be a telescoping or expandable/compressible tube or arm that contains the power and data cable 404. As the repositioning device 210 travels to the landing zone 412 on the top rear 410 of the trailer 406, the expandable cable securing device 418 extends out from the spool 416 and increases in length until the repositioning device 210 lands on the landing zone 412. When the repositioning device 210 lands and is secured on the landing zone 412, the cable securing device 418 lays on the top of the trailer 406 with the power and data cable 404 secured therein. The cable securing device 418 protects the power and data cable 404 and prevents the power and data cable 404 from moving during travel of the autonomous vehicle 400 and trailer 406. The repositioning device 210, including the sensor package 208, and expandable cable securing device 418 can return to the spool 416 when the autonomous vehicle 400 and trailer 406 arrive at their destination prior to removal of the trailer 406.

FIGS. 8A and 8B illustrate an alternative repositioning device 500, which can be a repositioning device, for use with autonomous vehicle 400 and trailer 406. In particular, FIG. 8A is a side plan view of the autonomous vehicle 400 and trailer 406 including the sensor package 208 showing the repositioning device 500 in the process of removing the sensor package 208, while FIG. 8B is a side plan view showing the repositioning device 500 positioning the sensor package 208 on the trailer 406. As can be seen in FIGS. 8A and 8B, the repositioning device 500 includes a robotic arm 502, e.g., a 6-axis robotic arm, that is movably mounted to a support beam 504, such that the robotic arm 502 is capable of grabbing the sensor package 208, moving laterally along the support beam 504 from the front of the trailer 406 to the rear 410 of the trailer 406, and repositioning the sensor package 208 on the top rear of the trailer 406. The robotic arm 502 can be mounted to the support beam 504 with one or more motors 506 capable of moving the robotic arm 502.

The repositioning device 500 may determine that the autonomous vehicle 400 and trailer 406 has driven up and parked adjacent thereto using one or more sensors thereof. Alternatively, the repositioning device 500 may communicate with the computing system 200, 300 of the autonomous vehicle 400 via a network, and receive an instruction from the computing system 200, 300 to activate and reposition the sensor package 208. Upon determining that the autonomous vehicle 400 and trailer 406 are in position, or receiving an activation signal, the repositioning device 500 can move the robotic arm 502 along the beam 504 until it is in proper position to grab the sensor package 208. The robotic arm 502 then grabs the sensor package 208, removes the sensor package 208 from the spool 402, moves along the beam 504 toward the rear 410 of the trailer 406 while holding the sensor package 208, and deposits the sensor package 208 on the top rear 410 of the trailer 406, e.g., on landing zone 412. As previously noted in connection with FIGS. 6A-6D, the spool 402 can allow for the power and data cable 404 to be drawn therefrom as the robotic arm 502 moves, actively dispense the power and data cable 404, and/or tighten the power and data cable 404 after the sensor package 208 is securely mounted to the trailer 406, e.g., via the retainers 416 shown in FIG. 6D. The repositioning device 500 can also assist with securely mounting the sensor package 208 to the trailer 406. For example, the robotic arm 502 can connect the retainers 416 to the sensor package 208, or can otherwise secure the sensor package 208 to the trailer 406 using mechanical, electromechanical, and/or magnetic means. The repositioning device 500 can also be used to remove the sensor package 208 from the trailer 406 and return it to the spool 402, e.g., if the repositioning device 500 is located at a delivery site.

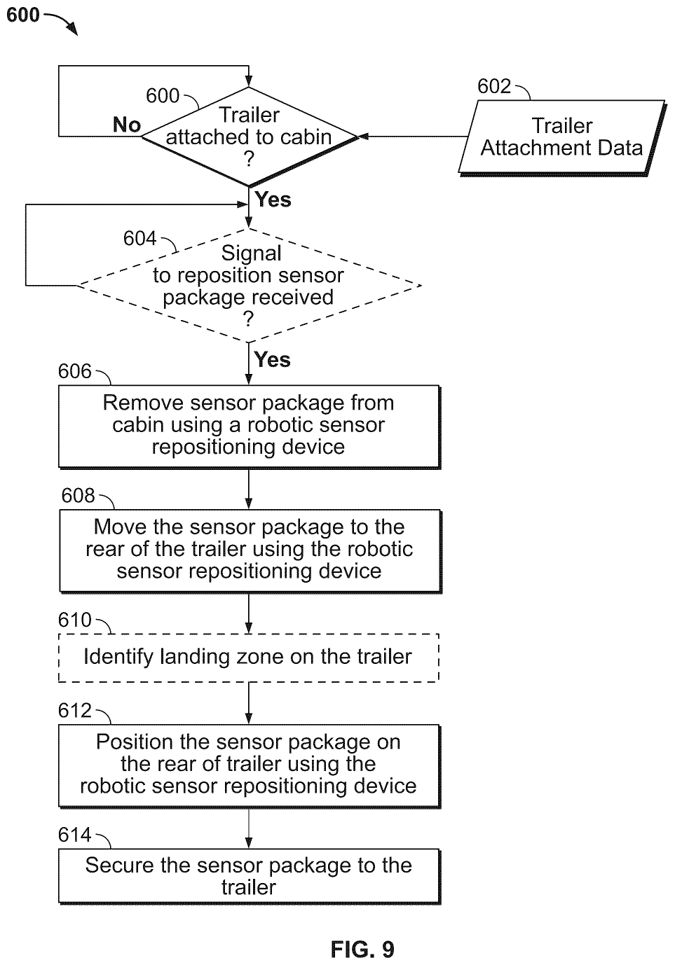

FIG. 9 is an exemplary flow chart 600 illustrating steps for repositioning a sensor package 208 on a trailer 406 of an autonomous vehicle 400. In step 600, a determination is made as to whether a trailer 406 is attached to the autonomous vehicle 400. Additionally and/or alternatively, step 600 can involve determining whether an autonomous vehicle 400 and trailer 406 are in proper position, e.g., when repositioning device 500 of FIGS. 8A and 8B is implemented. The determination of step 600 can be made based at least in part on trailer attachment data 602 as an input, which can be generated by sensors 408 of the autonomous vehicle 400 or sensors of the repositioning devices 210, 500. If a negative determination is made in step 600, then the process returns to the beginning and repeats. If a positive determination is made in step 600, then the process proceeds to optional step 604 in which a determination is made as to whether a signal to reposition the sensor package 208 has been received. In particular, as previously noted, the autonomous vehicle 400 can be optionally provided with a button or switch that can be actuated by an operator to activate the repositioning device 210, 500 and reposition the sensor package 208. If such a device is provided, then step 604 can be implemented in the process. If a negative determination is made in step 604, then step 604 is repeated until a positive determination is made. If a positive determination is made in step 604, e.g., the operator has issued an instruction to activate the repositioning device 210, 500, then the process proceeds to step 606. It is noted that in some embodiments, if a positive determination is made in step 600, then the process can automatically proceed directly to step 606 without first making the determination of step 604. Such process would not require the input of an operator. In step 606, the sensor package 208 is removed from the cab 114 using the repositioning device 210, 500. Next, in step 608, the repositioning device 210, 500 moves the sensor package 208 to the rear 410 of the trailer 406. This can involve, for example, aerially transporting the sensor package 208 using repositioning device 210 or moving robotic arm 502 along support beam 504. The process then proceeds to optional step 610 in which the landing zone 412 on the trailer 406 is identified. This can be achieved using data obtained by the sensor package 208, a computer vision system of the repositioning device 210, 500 or the computing system 200, and/or a beacon 414 that transmits a signal to the repositioning device 210, 500. Next, in step 612, the repositioning device 210, 500 positions the sensor package 208 on the rear 410 of the trailer 406, e.g., on the landing zone 412. The process then proceeds to step 614 in which the sensor package 208 is secured to the trailer 406, e.g., using the retainers 416.

The method operations may also include securing a power and data cable 404 to the trailer 406 and tightening the power and data cable 404. One or more of the foregoing method operations can be performed automatically.

An example technical effect of the methods, systems, and apparatus described herein includes at least the automatic transfer of a sensor package from an autonomous vehicle cab to a trailer using a repositioning device with minimal to no operator involvement.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A method of repositioning a sensor package mounted to a cabin of an autonomous vehicle and communicatively coupled to a computing system of the autonomous vehicle by a cable, comprising:
determining that a trailer has been attached to the cabin of the autonomous vehicle;
removing the sensor package from the cabin with a repositioning device after determining that the trailer has been attached to the cabin;
moving the sensor package to a rear of the trailer with the repositioning device;
positioning the sensor package on the rear of the trailer; and
securing the sensor package on the trailer using a retainer.

2. The method of claim 1, wherein the repositioning device includes a drone capable of flight and moving the sensor package includes aerially transporting the sensor package to the rear of the trailer.

3. The method of claim 1, wherein the repositioning device includes a robotic arm mounted external to the cabin and removing the sensor package from the cabin includes grabbing the sensor package with the robotic arm.

4. The method of claim 1, wherein removing the sensor package from the cabin and moving the sensor package to the rear of the trailer are performed automatically upon determining that the trailer has been attached to the cabin.

5. The method of claim 1, comprising:
receiving a signal from a user to activate the repositioning device,
wherein removing the sensor package from the cabin and moving the sensor package are performed upon receiving the signal.

6. The method of claim 1, comprising:
securing the cable to the trailer.

7. The method of claim 6, comprising:
tightening the cable upon securing the sensor package on the trailer.

8. The method of claim 1, comprising:
identifying a landing zone on the trailer containing the retainer; and
positioning the sensor package on the landing zone.

9. The method of claim 8, wherein the landing zone is identified using a computer vision system of the repositioning device.

10. A repositionable sensor system for an autonomous vehicle, comprising:
a sensor package including a plurality of sensors, the sensor package being mountable on a cabin of the autonomous vehicle and configured to be communicatively coupled to a computing system of the autonomous vehicle; and
a repositioning device, the repositioning device:
removing the sensor package after determining that a trailer has been attached to the cabin,
moving the sensor package to a rear of the trailer, and
positioning the sensor package on the rear of the trailer.

11. The system of claim 10, wherein the repositioning device includes a drone capable of flight and moving the sensor package includes aerially transporting the sensor package to the rear of the trailer.

12. The system of claim 10, wherein the repositioning device includes a robotic arm mounted external to the cabin and removing the sensor package includes grabbing the sensor package with the robotic arm.

13. The system of claim 10, wherein the repositioning device removes the sensor package and moves the sensor package to the rear of the trailer automatically after determining that the trailer has been attached to the cabin.

14. The system of claim 10, wherein the repositioning device removes the sensor package and moves the sensor package to the rear of the trailer upon receiving a signal from a user to activate the repositioning device.

15. The system of claim 10, comprising:
a cable connected to the sensor package and configured to be communicatively coupled to the computing system of the autonomous vehicle.

16. The system of claim 15, comprising:
means for securing the cable to the trailer.

17. The system of claim 15, comprising:
a retainer configured to secure the sensor package on the trailer; and
means for tightening the cable upon securing the sensor package on the trailer with a retainer.

18. The system of claim 15, wherein the cable is positioned within a cable holder that laterally secures the cable.

19. The system of claim 10, comprising:
a retainer configured to secure the sensor package on the trailer,
wherein the repositioning device identifies a landing zone on the trailer containing the retainer and positions the sensor package on the landing zone.

20. The system of claim 19, wherein the repositioning device includes a computer vision system and identifies the landing zone using the computer vision system.
